(19) United States
(12) Patent Application Publication
(10) Pub. No.: US 2026/0266618 A1
(43) Pub. Date: Sep. 10, 2026

(54) SYSTEM AND METHOD FOR ENHANCED ROUTING FOR TRAFFIC SIGNAL PREEMPTION AND PRIORITY

(71) Applicant: Neutron Edge, Inc., Los Altos, CA (US)

(72) Inventors: Norbert HEUSSER, Bornheim (DE); Carl TEMME, Los Altos, CA (US); Lars-Christian FUERSTENBERG, Glinde (DE)

(73) Assignee: Neutron Edge, Inc., Los Altos, CA (US)

(21) Appl. No.: 19/664,241

(22) Filed: Apr. 30, 2026

Related U.S. Application Data
(63) Continuation-in-part of application No. PCT/EP2025/055520, filed on Feb. 28, 2025.

(51) Int. Cl. G01C 21/34; G08G 1/0968

(52) U.S. Cl. CPC G01C 21/3492; G08G 1/096827; G08G 1/096838

(57) ABSTRACT

A system and method for giving priority to and navigating emergency vehicles and any other priority vehicles (such as transit vehicles, roadway maintenance vehicles, eco-friendly vehicles, and other vehicles for which it is desired to give priority treatment at traffic signals) by controlling vehicle traffic signals to allow safe and efficient passage of these priority vehicles. The system includes a software-based system and method for providing dynamic vehicle routing, navigation and traffic signal preemption and priority.

### CROSS-REFERENCE TO RELATED APPLICATIONS

The application claims priority to PCT/EP2025/055520 filed Feb. 28, 2025, the entire contents of which are incorporated herein by reference.

### FIELD OF THE INVENTION

The present invention relates to the technical field of systems and methods for navigating emergency vehicles and any other priority vehicles (such as transit vehicles, roadway maintenance vehicles, eco-friendly vehicles, and other vehicles for which it is desired to give priority treatment at traffic signals) and controlling vehicle traffic signals to allow safe and efficient passage of these priority vehicles. More specifically, the invention relates to a software-based system and method for providing dynamic vehicle routing, navigation and traffic signal preemption and priority.

### DESCRIPTION OF THE RELATED ART

In the field of traffic signal operation, preemption is a predefined entry in the traffic light controller, which may be activated by some external trigger, which can take many forms. One example is when a pedestrian pushes a button at a crosswalk to activate a walk signal. More complex preemption requests can be received from priority vehicles that are approaching the traffic signal. This involves the priority vehicle transmitting a signal that is received by the traffic controller when the vehicle is within a certain range of the traffic signal. This is often referred to as geofencing, whereas the priority vehicle comes within a certain physical range of the traffic signal a preemption will be activated.

Activating a specific preemption entry in the control will stop the normal cycle of the traffic light controller and try to activate a green light for one or multiple lanes/turns of the intersection as fast as possible. Most times these preemptions have a maximum time limit they will stay active until the controller switches back to normal cycle mode. When a traffic light controller is presented with a preemption, the traffic light controller will take into consideration the safety margins configured inside the controller (e.g., a pedestrian crossing has to be red for some given time before the controller is allowed to activate the green light on the crossed lanes).

Existing systems mainly consist of three methods of communicating the need to preempt a signal: optical transmitter, radio transmitter, and GPS-based preemption.

The first of these follow a legacy design that utilizes optical systems such as infrared emitters. These emitters are unreliable because the transmitter is directly exposed to the weather that a vehicle endures on an ongoing basis. This means that the lens of the infrared emitter is clouded by moisture and the plastic begins to discolor. This makes the emitter on the vehicle inaccurate and limited in range over very little time. Cleaning these devices is not a simple matter as they are installed on top of the very large trucks and vehicles, typically between the light bars. The receiver on the intersection has its own limitations. It consists of a sensor that is “looking” in each direction and thus is a collection of infrared receivers scattered around an intersection that must be wired to the local traffic cabinet. These wires often fail or are cut and make replacement difficult, often running underground to poles and then strung across guide wires to the middle of the intersection above the lights. Their placement makes tuning the direction and elevation nearly impossible as lane closures and a bucket truck are required in order to work on them. This system is VERY vulnerable and often there are installations with failure rates of 60% or more. Inherently these systems fail because of the amount of potential failure points. The truck installation, the intersection installation are both very vulnerable. The industry has recognized these issues and has begun to move away from this technology.

Utilizing a local, short-range radio signal, traffic-preemption system based on radio technology can effectively circumvent the shortcomings of optical transmitter alternatives. While still relying on directional transmission from an emitter, the radio-based approach remains unhindered by visual obstacles, lighting, or adverse weather conditions. Primary drawback of radio-based traffic signal preemption is the potential for interference from concurrent devices sharing the same frequency and location.

GPS (Global Positioning System) based preemption technology is not fully adequate for preempting signals because it lacks essential information about the vehicle's position, and actual, real-time route to destination planned by the driver in order to properly preempt lights. GPS has an accuracy of + or −3 meters. This level of accuracy hurts the capabilities of the system because errors in this range can incorrectly determine how the light needs to be preempted and lead to many potential problems. For instance, if the GPS shows the truck on the wrong side of the street, even with the correct heading, the light would be preempted differently than if the truck is shown on the correct side of the street, approaching the light. Inaccuracy like this in the lane information means that if the light preempts and traffic is released toward the emergency vehicle, there is a risk that the egress lanes could fill leaving no open lanes for the vehicle to proceed. This location accuracy also causes severe inaccuracies on heading. The possibility of successive updates being + or −6 meters from each other means that the calculated heading in one update could be almost 90 degrees different than the previous one. This means that the heading being reflected by the calculation between updates is seriously flawed and the wrong preemption may result from the calculation. This could have results as drastic as preempting a different approach and missing the preemption needed for the approaching vehicle.

These GPS systems also rely on multiple cloud-based systems for updates. These layers of cloud management all have inherent delays in API (Application Programming Interface) updates. A vehicle that utilizes a hardware device like a router typically will have its GPS updates sent to the telemetry services in the internet application cloud at most every second. Because these systems rely on cellular connections for updates, there are delays of seconds in the connection between the vehicle and the internet server in the cloud, through the mobile network service provider. Often updates are lost due to signal strength or are delayed because the messages must be routed through the Internet POP (Point of Presence) of the service provider to a server, often in a cloud service connected to the Internet. Speeds in signalized intersections average 35 mph so vehicles will travel over 250 feet between average updates. When telemetry is pulled from these systems to other cloud providers and then calculated the delays increase. There are measured delays in cities of almost 10 seconds between these updates. This means that the preemption signal is well behind the actual location of the vehicle and can mean that preemption can be late or completely invalid. In addition, there are many reasons that emergency vehicles may change their direction or route as they approach the intersection. Because these systems rely on delayed data, intersections that the vehicle is no longer passing through are often preempted. This unnecessarily disrupts traffic and increases the impact on congestion and travel times.

Centralized systems with GPS telemetry inputs are evolving. These systems are limited by the same type of accuracy problems as the cloud-based systems. Inaccuracies in positioning, heading and lane details, meaning that the predictions of the route may not be accurate. Furthermore, centralized and cloud systems may not have access to other information that is available on the vehicle, such as status of the task being performed, information from sensors and telematics systems, or information about the driver's preferred and planned route. This other information may be valuable in forming a signal preemption or priority request.

It is one object of the present invention to provide an emergency vehicle traffic signal preemption system that is able to calculate routes and estimated times of arrival (ETAs), and form signal priority requests entirely on the vehicle, and transmit those requests to a traffic signal without dependency on the intersection being in visual range.

Yet another object of the present invention is to provide an emergency vehicle preemption system having an emergency vehicle priority request transponder including a GPS-based real-time navigation interface and a preemption request module that is able to calculate routes and ETAs, and form signal priority requests entirely on the vehicle, not dependent on a central or cloud system to generate the request.

### SUMMARY OF THE INVENTION

The purpose of the present invention is to provide an improved emergency vehicle traffic signal preemption system including a pre-emption request module with the ability to calculate routes and ETAs and form signal priority requests entirely on the vehicle using a real-time geolocation and navigation system interface to form and send prioritization requests tied to the same route the drive is using with the in-vehicle navigation system so that the prioritization are as accurate and informative as possible and achieve optimized signal prioritization and preemption control.

Accordingly, optimized routes are constantly calculated in the vehicle based on the current position of the vehicle and the targeted destination. Based on the constantly calculated routes and ETAs (Estimated Time of Arrival) it is possible to request or update preemption or priority for traffic signals. If the vehicle deviates from the calculated route, a new route will be recalculated immediately and used as base for further preemption generation. Traffic signals will be preempted along the calculated route based on the calculated ETA. By providing ETAs and priority requests throughout the whole route, the signal timing can be adjusted well in advance of a vehicle arriving at the signal and requesting pre-emption, which means timing can be adjusted more gracefully, reducing disruption to other traffic. The proposed system is fully automatic and does not require the driver to manually invoke the pre-emption, although may allow for the driver to select from multiple possible routes or enter the driver's preferred and planned route. All pre-emption and priority requests are calculated based on information that is available in the vehicle, like the route the driver is following, position of the vehicle and the intersections, roadway conditions, planned stops, vehicle telematics information, task status, other situational information, etc. This implies that the system does not depend on a connection with a cloud or central software system to generate a priority or pre-emption request, nor does it require direct line of sight to the intersections, nor does it require the vehicle to be in a specific range or a particular geofenced area relative to the signal. It is therefore an aspect of the invention that the formation of pre-emption requests, including calculation of routes and ETAs, is performed in the vehicle and transmitted to the intersection system, i.e. the claimed system is able to run completely in the vehicle.

The invention also covers a computer program with program coding means which are suitable for conducting a method according to the invention described above when the computer program is run on a computer. The computer program itself as well as stored on a computer-readable medium is claimed.

The present invention is directed to a vehicle navigation and traffic signal preemption system. The vehicle navigation system is used for calculating a route between a set target destination and a repeatedly determined current vehicle position. The system further includes a preemption request module which is designed to generate a preemption or priority request for at least a next upcoming traffic signal, based on the determined current vehicle position and a calculated estimated time of arrival (based on the calculated route) at the traffic signal. The preemption request takes into consideration ingress approach data and egress approach data for the vehicle at the traffic signal.

The vehicle navigation system comprises a global navigation satellite system (GNSS) module for providing an accurate position of the vehicle and a routing engine for calculating the route to the destination. The vehicle navigation system also accesses an intersection geometry database and identifies traffic signal positions along the calculated route, which is queried by the vehicle navigation system of the routing engine.

Another aspect of the invention relates to a method for vehicle navigation and traffic signal pre-emption. A first step includes receiving input of a target destination. Next a step of repeatedly determining a current vehicle position, preferably by use of a GNSS module and calculating a route for the vehicle occurs. The method further includes identifying traffic signal positions along the calculated route and then calculating an estimated time of arrival (based on the calculated route) for at least a next upcoming traffic signal along the route. The next step in the method includes generating a preemption request for at least the next upcoming traffic signal based on the determined current vehicle position and the calculated estimated time of arrival, the preemption request taking into consideration ingress approach data and egress approach data for the vehicle at the traffic signal.

Further features and embodiments of the invention will become apparent from the description and the accompanying drawings.

It will be understood that the features mentioned above and those described hereinafter can be used not only in the combination specified but also in other combinations or on their own, without departing from the scope of the present invention.

The invention is schematically illustrated in the drawings by means of an embodiment by way of example and is hereinafter explained in detail with reference to the drawings. It is understood that the description is in no way limiting on the scope of the present invention and is merely an illustration of a preferred embodiment of the invention.

### BRIEF DESCRIPTION OF THE DRAWINGS

FIG. 1 shows a diagrammatic overview of the in-vehicle system of the invention;

FIG. 2 illustrates a flow diagram showing general sequence of calculating the route and ETAs for the intersections;

FIG. 3 is an illustration of a simple example of a use case of the invention; and

FIG. 4 is a plan view of a schematic topological depiction of an intersection preemption situation.

### DETAILED DESCRIPTION

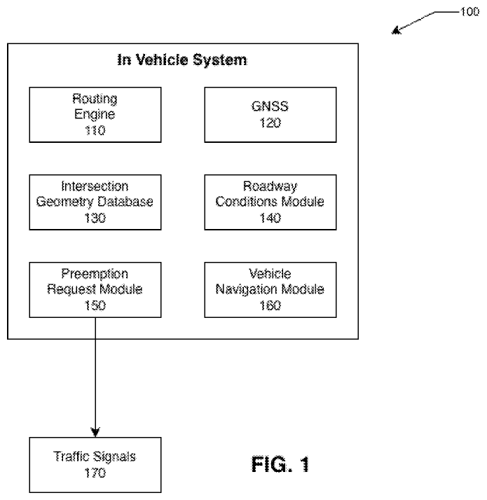

FIG. 1 shows an in-vehicle navigation and preemption system 100 (also called system 100). The system 100 includes one or more of the following modules: a routing engine 110 which calculates a route, preferably an optimized route, to the destination. A global navigation satellite system (GNSS) module 120 (sometimes used interchangeably with the term “GPS module”) which provides an accurate position of the vehicle including but not limited to latitude, longitude, speed, heading, direction, etc. A GNSS module is a compact electronic device that acts as a receiver for calculating precise real-time, velocity, and timing data by processing radio signals from one or more multiple satellite constellations (e.g., GPS, GLONASS, Galileo, BeiDou) for greater accuracy. In addition to using a GNSS module, other suitable modules/receivers can be used, including but not limited to GLONASS, Beidou, Galileo may be used alternatively. One of the important the invention is that the accuracy of the GNSS is less important than in other systems (e.g., GPS geofencing systems) because the GPS position in the present invention relates to the route, we expect the vehicle to drive and not a fence or distance to an intersection. An intersection geometry database 130 which provides the system with information about the lanes and approaches in the intersection. A roadway conditions module 140 which provides information about traffic, incidents, limits, bridges, tunnels, construction, lane closures, etc. A preemption request module 150 which generates preemption/priority requests based on vehicle position and ETA.

Preemption is when the preemption request module 150 generates a preemption request to switch or influence a traffic signal so that the priority vehicle can pass through the intersection in a safer, more efficient manner. Stated another way, preemption involves a system-generated request transmitted to one or more traffic signals to alter their timing based on the vehicle's calculated route, position, approach, and ETA so that the signal changes in advance to give priority to the priority vehicle travelling on a known route to pass safely and efficiently through an intersection controlled by a traffic signal, typically by switching the relevant approach to green.

A preemption request will be generated based on several factors including vehicle position (provided by the GNSS module 120), estimated time or arrival (provided by the routing engine 110 using data from the GNSS module 120) and ingress and egress approach data (provided by the intersection geometry database 130 accessed by the routing engine 110). The preemption request module 150 monitors the various inputs from the routing engine 110, GNSS module 120, intersection geometry database 130, and then generates one or more preemption requests to one or more upcoming traffic signals 170 when the ETA falls below a threshold. Also, the preemption request module 150 can generate preemption signals that will act on multiple traffic signals along the route. Using information from the intersection geometry database 130, the preemption request module 150 will also select the correct signal phase for the lane/approach that the vehicle will use and then generate a preemption request that will preempt the signal accordingly. For example, if the calculated route will involve a left turn the preemption request module can generate a preemption signal that will stop traffic in all directions and turn-on a left turn green indicator signal at the intersection where the left turn will occur to clear traffic out of the left lane and provide a clear lane for the priority vehicle (e.g. emergency vehicle) to travel.

A vehicle navigation module 160 which provides navigation information to the destination. All of the above-mentioned components of the vehicle navigation and preemption system 100 are hardware or software components located in a single unit on board a vehicle or are separate hardware or software components located in or residing within different hardware components, all within the same vehicle. FIG. 1 further shows traffic signals 170 which the in-vehicle navigation and preemption system 100 interacts with/influences, hence providing a safe crossing.

In the example depiction of FIG. 1, the intersection geometry database 130 and the roadway conditions module 140 are both shown to be part of the in-vehicle navigation and preemption system 100. Alternatively, one or both of the intersection geometry database 130 and the roadway conditions module 140 could be located in a (remote) central database with the in-vehicle system 100 having communication access to the remote intersection geometry database 130 and/or roadway conditions module 140.

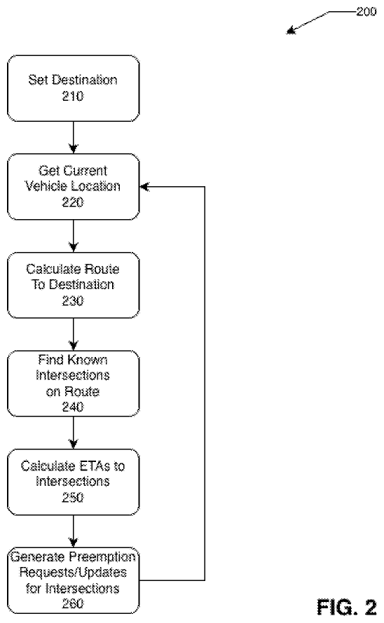

FIG. 2 shows a flow diagram 200 which illustrates the general sequence of calculating the route and ETAs for the intersections.

Setting the destination 210 will start the sequence. Then, the current vehicle position 220 of the vehicle is determined using the GNSS module 120. Using the vehicle's current position, the shortest route to the destination will be calculated during the calculate route to destination 230 step by the routing engine 110. The calculation will take any given roadway conditions into account, in order to produce a viable route, assisted by roadway conditions module 140.

Next, the route will be checked for known intersections 240. A known intersection is an intersection that has been configured in the database 130 of intersection geometries. The database of intersection geometries contains all intersections which can be preempted automatically.

For each known intersection, the ETA from the current vehicle position will be calculated 250 by the navigation module 160. If the ETA is below a certain threshold, the according signal 170 will be preempted 260. The certain threshold can depend on the intersection and approach (or target direction of travel). Additionally, it may vary depending on the time of day. Different situations or variable define the certain threshold. One example involves Pedestrian crossings that need additional time to clear the intersection, before a traffic light may change so we need a higher threshold. Another example threshold value example is an intersection crossing streets with higher speed limits that needs a higher threshold to make sure the security interval after the light turned red on the high-speed road is taken into account. Another example of a certain threshold is that depending on the traffic volume during different times of the day it makes sense to increase/decrease the threshold to find a good balance between flushing the intersection clear in the desired direction and reducing interruption of the overall traffic flow. Depending on the traffic volume during different times of the day it makes sense to increase/decrease the threshold to find a good balance between flushing the intersection clear in the desired direction and reducing interruption of the overall traffic flow.

According to the invention, the system may know if a signal has already been preempted previously and update the preemption in that case. After sending all preemptions, the sequence will return to the determination of the current vehicle position 220 and start all over again.

The proposed invention is a system that may preempt the traffic signal(s) before the vehicle reaches the intersection thus flushing the traffic and enabling a smooth and safe crossing of the intersection with a green light.

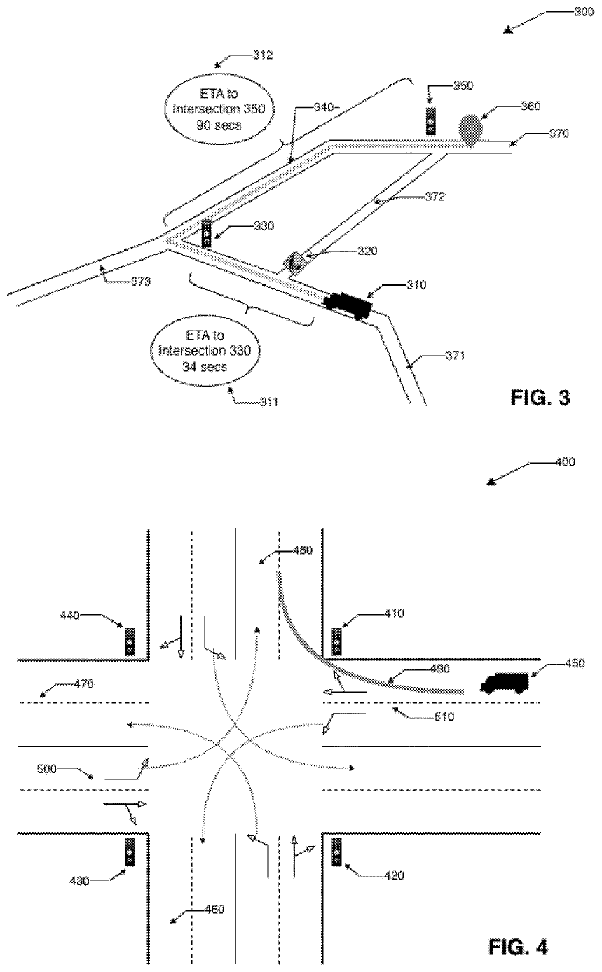

FIG. 3 depicts an example of such a use case 300, showing a network of roads 370, 371, 372, 373. A priority vehicle 310 is positioned on road 371, and in the priority vehicle 310 a target destination 360 is set which is located on road 370. The primary vehicle can be an emergency vehicle (e.g., ambulance, fire truck, police vehicle, etc.), however it is within the scope of this invention for the priority vehicle to be any type of vehicle that would benefit from traffic signal redemption in order to get to the destination as quickly and safely as possible. For example, it is possible that the in the future most vehicles might be equipped with an in-vehicle navigation and preemption system and traffic signals might be preempted for a priority vehicle that is travelling at a time of low traffic volume and traffic flow would be improved using the invention. Upon setting the target destination, the system 100 calculates the shortest (i.e., optimized) route 340 to the destination 360. The system may take roadway conditions (e.g., traffic, construction, bridge limits, tunnel restrictions, and other roadway hazards), like a construction 320 on road 372, into account and calculate a route that avoids such obstacles. Consequently, the priority vehicle 310 has to avoid road 372 which entails the need to pass by traffic lights 330 and 350 on the intersections of roads 371 and 373 and roads 370 and 372, respectively. The optimized route is therefore not necessarily the one with the least length but the one with the earliest estimated time of arrival at the target destination.

To calculate the route, the system takes the current position of vehicle 310 as provided by the GNSS module 120 of the system 100 inside the emergency vehicle 310 as the starting point of the route.

The system also queries the database 130 with intersection geometries of all known intersections with traffic signals. Using this information, the system checks for any of the known intersections on the calculated route 340. In this case, it will find the two mentioned intersections with traffic signals 330 and 350, respectively, i.e., on its route to the destination, the vehicle has to cross these two traffic signals 330 and 350.

Then, for each intersection the ETA (estimated time of arrival) is calculated. If the ETA is below a certain threshold, the preemption request module 150 generates a preemption request and sends it to the according traffic signal 330 and/or 350 using any appropriate means. The pre-emption request may be sent to the upcoming traffic signal, or to the upcoming and the next but one traffic signals, or the upcoming and multiple further upcoming traffic signals.

As the priority vehicle 310 proceeds to the destination 360, the route is continuously recalculated to ensure it is still the most accurate and safe route to the destination avoiding roadway obstacles.

The recalculation is also useful if the priority vehicle 310 has deviated away from the original route. This continuous recalculation is one of the aspects that makes the system unique. During the recalculation, which also happens on the way to the traffic signal 330, new intersections are identified, ETAs are determined and preemptions are generated accordingly. Every additional preemption for the same signal will update the previous one and will make the ETA more accurate.

Potentially, multiple traffic signals can be preempted at the same time if they are close to each other and the ETA for each is below a certain threshold.

For use case 300, both intersections 330 and 350 could be preempted simultaneously and the priority vehicle 310 could pass both intersections with a green light and reach its destination without stopping at a signal if both ETAs are below the predetermined thresholds. For example, in use case 300, the threshold for the traffic signal 330 at the first intersection is 45 second, while the threshold for the traffic signal 350 at the second intersection is 100 seconds. While the priority vehicle 310 is traveling on the route, at one particular moment in time a first intersection ETA 311 calculated for the amount of time it will take the priority vehicle 310 to travel the distance to the intersection with traffic signal 330 is calculated to be 34 seconds. At the same particular moment in time a second intersection ETA 312 calculated for the amount of time it will take the priority vehicle 310 to travel the distance to the intersection with traffic signal 350 is calculated to be 90 seconds For this particular example the times of 34 second and 90 seconds are below the predetermined threshold values for the respective traffic signals 330,350, so both signals can be preempted for the priority vehicle 310.

The solution according to the invention in general can be used for a wide variety of means of transportation including, but not limited, to emergency vehicles, public transport, goods transport, etc.

A typical intersection has multiple ingress/egress (incoming and exiting) lanes and approaches, with multiple traffic lights controlling the flow of traffic through the intersection. The traffic signal timing is defined by the traffic administration and programmed into the traffic control system.

A typical example of a four-way intersection 400 is illustrated in FIG. 4. The shown intersection 400 has four ingress approaches and four egress approaches. Each ingress approach has a traffic light 410, 420, 430, and 440.

In the depicted example situation of intersection 400, a vehicle 450 enters the intersection 400 on approach 510 and has three possible egress approaches: left turn 460, straight exit 470, and right turn 480.

The vehicle 450 is about to cross the intersection and the in-vehicle navigation and preemption system 100 wants to preempt the intersection. In order to preempt and switch the correct signal, the in-vehicle navigation and preemption system 100 determines on which ingress approach it will enter and on which egress approach it will leave the intersection 400.

In the example represented in FIG. 4, the system calculates a route depicted by reference numeral 490 and identifies the intersections along the path to the destination. In order to identify the approaches, the system has to have detailed information about the exact geometry of the intersection and the associated approaches to each lane. This information may be delivered into the system using geometry information such as a MAP message from the traffic controller (MAP: standardized description of the intersection topology).

In the use case 400, the in-vehicle navigation and preemption system 100 determines that the vehicle 450 enters the intersection on approach 510 and leaves the intersection on approach 480. The system will preempt the intersection approach 510 with the ETA of the vehicle in order to switch the corresponding traffic signal 410 to green for the vehicle 450 to go through the intersection without stopping and in a safe manner.

In case the ingress approach 510 has two traffic lights for its right lane (for the right turn and the straight exit) and its left lane (for the left turn), the system could either preempt only the right lane traffic signal leaving the left lane signal on red, or, in order to also flush the left lane for increased safety, preempt both lanes'traffic signals.

Additionally, similar to the description above in connection with FIG. 3, the system could also preempt a subsequent traffic signal following on the egress approach 480 in order to flush the lanes of the egress approach 480 to be taken by the vehicle 450 for increased safety.

The manner of preempting the signal is through communication with a traffic controller (i.e., a traffic control center controlling the given traffic signal), either direct or through a messaging system compatible with the traffic controller protocols. This method ensures that the traffic controller has all information necessary to make the decision about the timing of preemption based on its own timing plans. This enables the system to properly influence the traffic controller and maintain safety control with the traffic controller.

The calculation of a route follows an abstract network of interconnected streets and roads. This network is largely static in nature, certainly for the general route calculation. However, other dynamically changing conditions will affect the vehicle routing such as temporary constructions, lane closures, traffic, accidents, etc.

Additionally, there are special conditions that may only impact certain types of vehicles, such as very heavy or exceptionally wide and/or long vehicles. These vehicles may face restrictions on bridges or narrow streets and similar situations. In order to produce a viable route for a specific vehicle under certain circumstances, the route calculation has to account for dynamic and special roadway conditions.

For the system to be able to respect any roadway conditions, these conditions have to be configured in the system. Use case 300 in FIG. 3 illustrates such a situation. The shortest route for vehicle 310 would be to use street or road 372 in order to reach the destination 360. Under normal circumstances, the routing would actually find that path. However, there is a temporary construction that prevents the vehicle from using street 372. The construction has to be known beforehand to the system. Now the system can reroute the vehicle to use road 373 instead in order to be able to reach its targeted destination without issues.

If the real-world scenario entails computing a path to a specific destination, such as for an emergency vehicle, the system performs optimally when it displays the calculated route to the vehicle operator. This increases the likelihood that the vehicle will adhere to the designated route. In cases where the driver decides to stray from the current route, a new route will be promptly computed, accompanied by comprehensive navigation instructions for the operator.

The presented system can be deployed in a variety of use cases including, but not limited to ambulances, fire engines, police vehicles, public transport, freight/shipping, etc. Each use case can leverage the system in a unique manner. An ambulance, for example, could have two destinations: first the emergency location and second the hospital to take the patient to. The system would navigate the ambulance to the first destination and then to the second using the system as described above for each part of the route. For public transport like a bus, the route would be static unless certain roadway conditions limit the bus from adhering to the preassigned route in which case route recalculation is needed to get the bus to the next stop. The system will be able to prioritize and influence the traffic signal(s) based on adherence. Fire and police vehicles would be managed as described above.

The components of the illustrative devices, systems and methods employed in accordance with the illustrated embodiments can be implemented, at least in part, in digital electronic circuitry, analog electronic circuitry, or in computer hardware, firmware, software, or in combinations of them. These components can be implemented as a collection of instructions executed by a processing device, for example, as a computer program product such as a computer program, program code or computer instructions tangibly embodied in an information carrier, or in a machine-readable storage device, for execution by, or to control the operation of, data processing apparatus such as a programmable processor, a microprocessor, a computer, or multiple computers. The term “processing unit” as used in this application is comprehensive of any such computer, processor, microchip processor, integrated circuit, or any other element(s), whether singly or in multiple parts, capable of carrying programming for performing the functions, methods and flowcharts provided herein. The processing unit may be a single such element which is resident on a printed circuit board with the other electronic elements. It may, alternatively, reside remotely from the other elements systems described herein. For example, but without limitation, at least one processing unit may take the form of programming in the onboard computer of a vehicle within the door, a latch or at other locations within the vehicle as examples. The processing unit may also reside in multiple locations or comprise multiple components.

A list of instructions, for example a computer program, can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network. Also, functional programs, codes, and code segments for accomplishing the illustrative embodiments can be easily construed as within the scope of claims exemplified by the illustrative embodiments by programmers skilled in the art to which the illustrative embodiments pertain. Method steps associated with the illustrative embodiments can be performed by one or more programmable processors executing a computer program, code, or instructions to perform functions (e.g., by operating on input data and/or generating an output). Method steps can also be performed by, and apparatus of the illustrative embodiments can be implemented as, special purpose logic circuitry, e.g., an FPGA (field programmable gate array) or an ASIC (application-specific integrated circuit), for example.

The various illustrative logical blocks, modules, algorithms, steps, and circuits described in connection with the embodiments disclosed herein may be implemented or performed with a general purpose processor, a digital signal processor (DSP), an ASIC, a FPGA or other programmable logic device, discrete gate or transistor logic, discrete hardware components, or any combination thereof designed to perform the functions described herein. A general-purpose processor may be a microprocessor, but in the alternative, the processor may be any conventional processor, micro processing unit, or state machine, as examples. A processor may also be implemented as a combination of computing devices, e.g., a combination of a DSP and a microprocessor, a plurality of microprocessors, one or more microprocessors in conjunction with a DSP core, or any other such configuration.

Processors suitable for the execution of a computer program include, by way of example, both general and special purpose microprocessors, and any one or more processors of any kind of digital computer. Generally, a processor will receive instructions and data from a read-only memory or a random-access memory or both. The essential elements of a computer are a processor for executing instructions and one or more memory devices for storing instructions and data. Generally, a computer will also include or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example, semiconductor memory devices, e.g., electrically programmable read-only memory or ROM (EPROM), electrically erasable programmable ROM (EEPROM), flash memory devices, and data storage disks (e.g., magnetic disks, internal hard disks, or removable disks, magneto-optical disks, and CD-ROM and DVD-ROM disks). The processor and the memory can be supplemented by or incorporated in special purpose logic circuitry.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, algorithms, and steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of claims exemplified by the illustrative embodiments. A software module may reside in random access memory (RAM), flash memory, ROM, EPROM, EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. In other words, the processor and the storage medium may reside in an integrated circuit or be implemented as discrete components.

Computer-readable non-transitory media includes all types of computer readable media, including magnetic storage media, optical storage media, flash media, and solid-state storage media. It should be understood that software can be installed in and sold with a central processing unit (CPU) device. Alternatively, the software can be obtained and loaded into the CPU device, including obtaining the software through physical medium or distribution system, including, for example, from a server owned by the software creator or from a server not owned but used by the software creator. The software can be stored on a server for distribution over the Internet, for example.

We claim:

1. An in-vehicle navigation and preemption system comprising:
a vehicle navigation system for calculating a route to a set target destination between a repeatedly determined current vehicle position and a target destination; and
a preemption request module that generates a preemption request for at least a next upcoming traffic signal based on the determined current vehicle position and a calculated estimated time of arrival at the traffic signal determined along the route calculated by the vehicle navigation system, the preemption request taking into consideration ingress approach data and egress approach data for the vehicle at the traffic signal.

2. The in-vehicle navigation and preemption system of claim 1, wherein the vehicle navigation system comprises a global navigation satellite system (GNSS) module for providing an accurate position of the vehicle; and a routing engine for calculating the route to the destination.

3. The in-vehicle navigation and preemption system of claim 1, wherein the vehicle navigation system comprises access to an intersection geometry database.

4. The in-vehicle navigation and preemption system of claim 3, wherein the routing engine communicates with the intersection geometry database and identifies traffic signal positions along the calculated route.

5. The in-vehicle navigation and preemption system of claim 1, wherein the vehicle navigation system comprises access to a roadway conditions module.

6. The in-vehicle navigation and preemption system of claim 5, wherein the routing engine communicates with the roadway conditions module when calculating the route to the destination.

7. The in-vehicle navigation and preemption system of claim 1, wherein the preemption request module is designed to transmit the preemption request to the traffic signal if the estimated time of arrival at the said traffic signal is below a predetermined threshold.

8. The in-vehicle navigation and preemption system of claim 1, wherein the preemption request module generates the preemption request for the next upcoming traffic signal and the at least next but one traffic signal.

9. The in-vehicle navigation and preemption system of claim 8, wherein the preemption request module transmits the preemption request to multiple traffic signals if the estimated time of arrival at the next upcoming traffic signals is below a predetermined threshold.

10. The in-vehicle navigation and preemption system of claim 1, wherein the preemption request covers only the ingress lane corresponding to the calculated route.

11. The in-vehicle navigation and preemption system of claim 10, wherein the preemption request extends to one or more non-conflicting parallel lanes of the ingress lane corresponding to the calculated route.

12. A method for vehicle navigation and traffic signal preemption, comprising the following steps:
receiving input of a target destination;
repeatedly determining a current vehicle position;
calculating a route for the vehicle;
identifying traffic signal positions along the calculated route;
calculating an estimated time of arrival for at least a next upcoming traffic signal along the route;
generating a preemption request for at least the next upcoming traffic signal based on the determined current vehicle position and the calculated estimated time of arrival, the preemption request taking into consideration ingress approach data and egress approach data for the vehicle at the traffic signal.

13. The method of claim 12, wherein the step of calculating a route includes taking into consideration of roadway conditions.

14. The method of claim 12, wherein the preemption request is transmitted to the traffic signal if the estimated time of arrival at the said traffic signal is below a predetermined threshold.

15. The method of claim 12, wherein the preemption request is generated for the next upcoming traffic signal and the at least next but one traffic signal.

16. The method of claim 15, wherein the preemption request is transmitted to both traffic signals if the estimated time of arrival at the next upcoming traffic signal is below a predetermined threshold.

17. The method of claim 12, wherein the preemption request covers only the ingress lane corresponding to the calculated route.

18. The method of claim 17, wherein the preemption request extends to one or more non-conflicting parallel lanes of the ingress lane corresponding to the calculated route.

19. The method of claim 12 further comprising the step of providing a computer program product with a computer-readable medium and a computer program stored on the computer-readable medium with program coding means which are suitable for conducting the method for vehicle navigation when the computer program is run on a processing unit.

20. The method of claim 19, wherein the processing unit is a vehicle navigation and traffic signal preemption system.
